(19) United States
(12) Patent Application Publication
(10) Pub. No.: US 2026/0247346 A1
(43) Pub. Date: Aug. 20, 2026

(54) PAGING EARLY INDICATION WITH PAGING ADAPTATION

(71) Applicant: QUALCOMM Incorporated, San Diego, CA (US)

(72) Inventors: Qing LI, Princeton Junction, NJ (US); Hung Dinh LY, San Diego, CA (US); Navid ABEDINI, Basking Ridge, NJ (US); Stefan BRUECK, Neunkirchen am Brand (DE); Karl Georg HAMPEL, Jersey City, NJ (US)

(21) Appl. No.: 19/398,935

(22) Filed: Nov. 24, 2025

Related U.S. Application Data
(60) Provisional application No. 63/758,940, filed on Feb. 14, 2025.

(51) Int. Cl. H04W 68/02; H04W 76/40

(52) U.S. Cl. CPC H04W 68/02; H04W 76/40

(57) ABSTRACT

Various aspects of the present disclosure generally relate to wireless communication. In some aspects, a user equipment (UE) may transmit a paging support indication that specifies at least one of: one or more supported paging frames per paging cycle (N) values, or one or more supported paging occasions per paging frame (Ns) values. The UE may receive a paging setup indication that specifies at least one of: a selected N value, or a selected Ns value, the at least one of the selected N value or the selected Ns value being based at least in part on the at least one of the one or more supported N values or the one or more supported Ns values. Numerous other aspects are described.

### CROSS-REFERENCE TO RELATED APPLICATION

This Patent Application claims priority to U.S. Provisional Patent Application No. 63/758,940, filed on Feb. 14, 2025, entitled “PAGING EARLY INDICATION WITH PAGING ADAPTATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with a paging early indication with paging adaptation.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A user equipment (UE) operating in an idle or inactive mode may monitor a control channel during a paging occasion (PO) within a paging frame, and the UE may determine whether a page is scheduled for the UE during the PO. For example, the UE may identify a paging frame within a discontinuous reception (DRX) cycle that is configured for the UE. Based at least in part on operating an idle or inactive mode, the UE may wake up from the idle or inactive mode once in every DRX cycle during the PO associated with the UE. At the time that the UE wakes up from the idle or inactive mode, the UE may be unaware of whether there will be a page for the UE during the PO. Consequently, when the UE wakes up during the PO associated with the UE, an entire receive chain is activated to enable the UE to receive and decode a page directed to the UE. This may increase power consumption at the UE, as components needed to receive and decode the page may not need to be activated if there is no page scheduled for the UE. Accordingly, in some cases, a wireless network may support a paging early indication (PEI), sometimes referred to as a wakeup signal (WUS), to improve power efficiency associated with paging reception at a UE.

### SUMMARY

The systems, methods, and devices of this disclosure each have several innovative aspects, no single one of which is solely responsible for the desirable attributes disclosed herein.

Some aspects described herein relate to a method of wireless communication performed by a user equipment (UE). The method may include transmitting a paging support indication that specifies at least one of, one or more supported paging frames per paging cycle (N) values, or one or more supported paging occasions per paging frame (Ns) values. The method may include receiving a paging setup indication that specifies at least one of, a selected N value, or a selected Ns value, the at least one of the selected N value or the selected Ns value being based at least in part on the at least one of the one or more supported N values or the one or more supported Ns values.

Some aspects described herein relate to a method of wireless communication performed by a network node. The method may include receiving a paging support indication that specifies at least one of, one or more supported N values, or one or more supported Ns values. The method may include transmitting a paging setup indication that specifies at least one of, a selected N value, or a selected Ns value, the at least one of the selected N value or the selected Ns value being based at least in part on the at least one of the one or more supported N values or the one or more supported Ns values.

Some aspects described herein relate to a method of wireless communication performed by a network node. The method may include relaying, as a bypass mechanism, a first non-stratum access (NAS) message from a UE to a core network, the first NAS message comprising a paging support indication that specifies at least one of, one or more supported N values, or one or more supported Ns values. The method may include relaying, as the bypass mechanism, a second NAS message from the core network to the UE, the second NAS message comprising a paging setup indication that specifies at least one of, a selected N value that is based at least in part on the one or more supported N values, or a selected Ns value that is based at least in part on the one or more supported Ns values. The method may include receiving an indication that is directed to the network node, the indication specifying the at least one of the selected N value or the selected Ns value.

Some aspects described herein relate to a non-transitory computer-readable medium that stores a set of instructions for wireless communication by a UE. The set of instructions, when executed by one or more processors of the UE, may cause the UE to transmit a paging support indication that specifies at least one of, one or more supported N values, or one or more supported Ns values. The set of instructions, when executed by one or more processors of the UE, may cause the UE to receive a paging setup indication that specifies at least one of, a selected N value, or a selected Ns value, the at least one of the selected N value or the selected Ns value being based at least in part on the at least one of the one or more supported N values or the one or more supported Ns values.

Some aspects described herein relate to a non-transitory computer-readable medium that stores a set of instructions for wireless communication by a network node. The set of instructions, when executed by one or more processors of the network node, may cause the network node to receive a paging support indication that specifies at least one of, one or more supported N values, or one or more supported Ns values. The set of instructions, when executed by one or more processors of the network node, may cause the network node to transmit a paging setup indication that specifies at least one of, a selected N value, or a selected Ns value, the at least one of the selected N value or the selected Ns value being based at least in part on the at least one of the one or more supported N values or the one or more supported Ns values.

Some aspects described herein relate to a non-transitory computer-readable medium that stores a set of instructions for wireless communication by a network node. The set of instructions, when executed by one or more processors of the network node, may cause the network node to relay, as a bypass mechanism, a first NAS message from a UE to a core network, the first NAS message comprising a paging support indication that specifies at least one of, one or more supported N values, or one or more supported Ns values. The set of instructions, when executed by one or more processors of the network node, may cause the network node to relay, as the bypass mechanism, a second NAS message from the core network to the UE, the second NAS message comprising a paging setup indication that specifies at least one of, a selected N value that is based at least in part on the one or more supported N values, or a selected Ns value that is based at least in part on the one or more supported Ns values. The set of instructions, when executed by one or more processors of the network node, may cause the network node to receive an indication that is directed to the network node, the indication specifying the at least one of the selected N value or the selected Ns value.

Some aspects described herein relate to a UE. The UE may include a processing system. The processing system may include one or more processors and one or more code-storing memories coupled with the one or more processors. The processing system may be configured to cause the UE to transmit a paging support indication that specifies at least one of, one or more supported N values, or one or more supported Ns values. The processing system may be configured to cause the UE to receive a paging setup indication that specifies at least one of, a selected N value, or a selected Ns value, the at least one of the selected N value or the selected Ns value being based at least in part on the at least one of the one or more supported N values or the one or more supported Ns values.

Some aspects described herein relate to a network node. The network node may include a processing system. The processing system may include one or more processors and one or more code-storing memories coupled with the one or more processors. The processing system may be configured to cause the network node to receive a paging support indication that specifies at least one of, one or more supported N values, or one or more supported Ns values. The processing system may be configured to cause the network node to transmit a paging setup indication that specifies at least one of, a selected N value, or a selected Ns value, the at least one of the selected N value or the selected Ns value being based at least in part on the at least one of the one or more supported N values or the one or more supported Ns values.

Some aspects described herein relate to a network node. The network node may include a processing system. The processing system may include one or more processors and one or more code-storing memories coupled with the one or more processors. The processing system may be configured to cause the network node to relay, as a bypass mechanism, a first NAS message from a UE to a core network, the first NAS message comprising a paging support indication that specifies at least one of, one or more supported N values, or one or more supported Ns values. The processing system may be configured to cause the network node to relay, as the bypass mechanism, a second NAS message from the core network to the UE, the second NAS message comprising a paging setup indication that specifies at least one of, a selected N value that is based at least in part on the one or more supported N values, or a selected Ns value that is based at least in part on the one or more supported Ns values. The processing system may be configured to cause the network node to receive an indication that is directed to the network node, the indication specifying the at least one of the selected N value or the selected Ns value.

Some aspects described herein relate to an apparatus for wireless communication. The apparatus may include means for transmitting a paging support indication that specifies at least one of, one or more supported N values, or one or more supported Ns values. The apparatus may include means for receiving a paging setup indication that specifies at least one of, a selected N value, or a selected Ns value, the at least one of the selected N value or the selected Ns value being based at least in part on the at least one of the one or more supported N values or the one or more supported Ns values.

Some aspects described herein relate to an apparatus for wireless communication. The apparatus may include means for receiving a paging support indication that specifies at least one of, one or more supported N values, or one or more supported Ns values. The apparatus may include means for transmitting a paging setup indication that specifies at least one of, a selected N value, or a selected Ns value, the at least one of the selected N value or the selected Ns value being based at least in part on the at least one of the one or more supported N values or the one or more supported Ns values.

Some aspects described herein relate to an apparatus for wireless communication. The apparatus may include means for relaying, as a bypass mechanism, a first NAS message from a UE to a core network, the first NAS message comprising a paging support indication that specifies at least one of, one or more supported N values, or one or more supported Ns values. The apparatus may include means for relaying, as the bypass mechanism, a second NAS message from the core network to the UE, the second NAS message comprising a paging setup indication that specifies at least one of, a selected N value that is based at least in part on the one or more supported N values, or a selected Ns value that is based at least in part on the one or more supported Ns values. The apparatus may include means for receiving an indication that is directed to the network node, the indication specifying the at least one of the selected N value or the selected Ns value.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIGS. 3A-3B are diagrams illustrating a first example and a second example, respectively, of paging configurations.

FIG. 4 is a diagram illustrating an example of a wireless communication process between a user equipment (UE), a network node, and a core network.

FIG. 5 is a diagram illustrating an example of a wireless communication process between a UE and a network node.

FIG. 6 is a diagram illustrating an example process performed, for example, at a UE or an apparatus of a UE.

FIG. 7 is a diagram illustrating an example process performed, for example, at a network node or an apparatus of a network node.

FIG. 8 is a diagram illustrating an example process performed, for example, at a network node or an apparatus of a network node.

FIG. 9 is a diagram of an example apparatus for wireless communication.

FIG. 10 is a diagram of an example apparatus for wireless communication.

### DETAILED DESCRIPTION

A user equipment (UE) operating in an idle or inactive mode may monitor a control channel during a paging occasion (PO) within a paging frame, and the UE may determine whether a page is scheduled for the UE during the PO. For example, the UE may identify a paging frame within a discontinuous reception (DRX) cycle that is configured for the UE. Based at least in part on operating an idle or inactive mode, the UE may wake up from the idle or inactive mode once in every DRX cycle during the PO associated with the UE. At the time that the UE wakes up from the idle or inactive mode, the UE may be unaware of whether there will be a page for the UE during the PO. Consequently, when the UE wakes up during the PO associated with the UE, an entire receive chain is activated to enable the UE to receive and decode a page directed to the UE. This may increase power consumption at the UE, as components needed to receive and decode the page may not need to be activated if there is no page scheduled for the UE. Accordingly, in some cases, a wireless network may support a paging early indication (PEI), sometimes referred to as a wakeup signal (WUS), to improve power efficiency associated with paging reception at a UE.

As part of an effort to increase network energy saving (NES) in a wireless network, a communication standard may adapt one or more common signal transmissions, one or more channel transmissions, or a combination thereof, in a manner that increases energy savings. Examples may include synchronization signal block (SSB) adaptation in the time domain, a physical random access channel (PRACH) adaptation in the time domain, and an adaptation of one or more POs.

As an example of a PO adaptation, a communication standard may initially specify, as part of a paging process between a network node and a UE, a supported value for a number or quantity of paging frames per paging cycle (N), a supported value for a number or quantity of paging occasions per paging frame (Ns), or a combination of the two. An adaptation to the paging process may include introducing an additional supported value for N, an additional supported value for Ns, or a combination of the two. The increase in supported values for N, Ns, or the combination, may lead to a mismatch between when a network node transmits a PEI, and when a UE monitors for the PEI, resulting in the UE failing to receive the PEI.

To illustrate, a particular release of the communication standard may include multiple adaptations, such as the SSB adaptation, the PRACH adaptation, and the PO adaptation. For some scenarios, a UE may indicate support for the particular release with more than one features, but only support a first feature of the particular release (e.g., the SSB adaptation or the PRACH adaptation). That is, the UE may indicate support for the particular release without including support a second feature of the particular release (e.g., the PO adaptation). In indicating support for the particular release, the UE may not communicate the lack of support for a second feature of the adaptations, potentially resulting in a mismatch between timing used by a network node to transmit a PEI and timing used by a UE to receive the PEI and the UE failing to detect or receive a PEI that is directed to the UE. For instance, the UE may not include support for the additional supported value for N, the additional supported value for Ns, or a combination of the two, and the network node may use the additional supported value for N, the additional supported value for Ns, or a combination of the two to compute a paging frame (PF) location, a PO location, a PEI occasion (PEI-O) location, or any combination thereof. Conversely, the UE may use initial supported values for N, Ns, or a combination thereof, to compute the PF location, the PO location, or the PEI-O location, resulting in a timing mismatch. Alternatively, or additionally, the network node and the UE may derive a different PO subgroup assignment for UE, also resulting in the UE not detecting or receiving a PEI that is directed to the UE.

Various aspects relate generally to a PEI with paging adaptation. Some aspects more specifically relate to signaling that enables a network node and a UE to synchronize or align computations that are used to derive paging related locations, such as a PF location, a PO location, a PEI-O location, or any combination thereof. In some aspects, a UE may transmit a paging support indication that specifies at least one of: one or more supported N values, or one or more supported Ns values. As one example, the UE may indicate support for one or more communication standard specified N values that are supported by the UE, one or more communication standard specified Ns values that are supported by the UE, or any combination of the two. The UE may receive a paging setup indication that specifies at least one of: a selected N value, or a selected Ns value. The selected N value or the selected Ns value may be selected by a core network (CN), or a non-CN network node. In some aspects, the selected N value, the selected Ns value, or any combination thereof, may be based at least in part on the supported N value(s), the supported Ns value(s), or any combination thereof, that are indicated by the UE.

In some aspects, a network node (e.g., a CN network node or a non-CN network node) may receive a paging support indication that specifies at least one of: one or more supported N values, or one or more supported Ns values. The supported N values, the supported Ns values, or any combination thereof, may be specific to a particular UE. Based at least in part on receiving the paging support indication, the network node may transmit a paging setup indication that specifies at least one of: a selected N value, or a selected Ns value. In some aspects, the network node may choose the selected N value, the selected Ns value, or both from the supported N value(s), the supported Ns value(s), or both.

Particular aspects of the subject matter described in this disclosure can be implemented to realize one or more of the following potential advantages. In some examples, by a UE indicating any combination of supported N value(s) or supported Ns value(s), the described techniques can be used to enable a network node (e.g., a CN network node or a non-CN network node) to choose or select an N value, an Ns value, or any combination in a manner that maintains synchronization with the UE.

Alternatively, or additionally, the network node may transmit an indication of the selected N value, the selected Ns value, or any combination thereof, to mitigate a mismatch with the UE with regards to deriving paging related locations (e.g., a PF location, a PO location, or a PEI-O location), deriving a PO subgroup assignment to the UE, or a combination of the two. Mitigating a mismatch in deriving paging related locations or driving the PO subgroup assignment to the UE may enable a network node to transmit a PEI using timing and information that is expected by the UE, resulting in the UE detecting and receiving a PEI that is directed to the UE.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, NES, low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

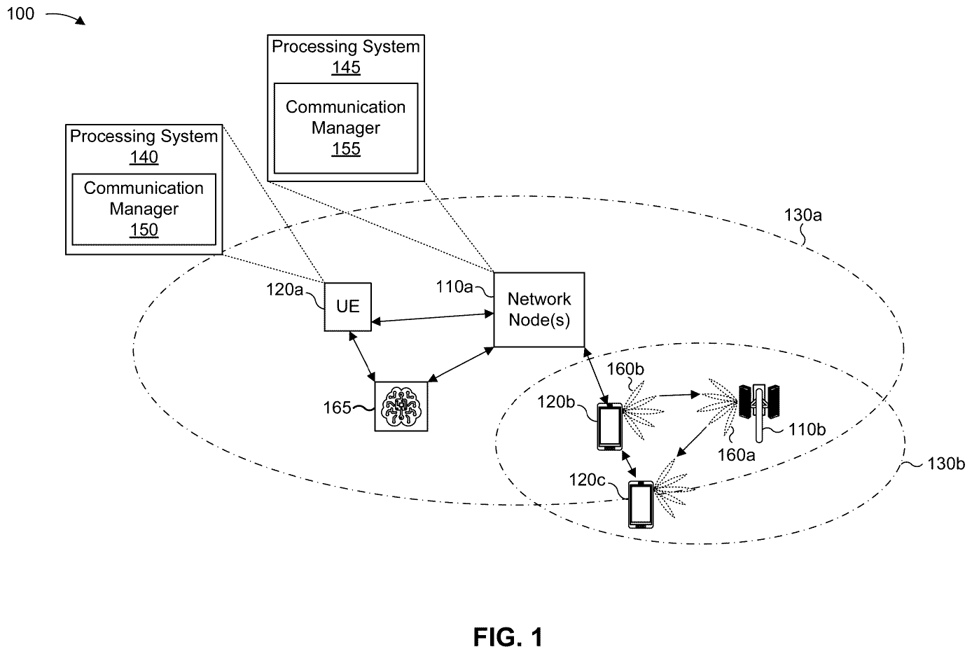

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs).

A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (L1), a rank indicator (RI), or measurement information (for example, a layer 1 (L1)—reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a UE (e.g., a UE 120) may include a communication manager 150. As described in more detail elsewhere herein, the communication manager 150 may transmit a paging support indication that specifies at least one of: one or more supported N values, or one or more supported Ns values; and receive a paging setup indication that specifies at least one of: a selected N value, or a selected Ns value, the at least one of the selected N value or the selected Ns value being based at least in part on the at least one of the one or more supported N values or the one or more supported Ns values. Additionally, or alternatively, the communication manager 150 may perform one or more other operations described herein.

In some aspects, a network node (e.g., a network node 110 that is a CN network node or a non-CN network node) may include a communication manager 155.

As described in more detail elsewhere herein, the communication manager 155 may receive a paging support indication that specifies at least one of: one or more supported N values, or one or more supported Ns values; and transmit a paging setup indication that specifies at least one of: a selected N value, or a selected Ns value, the at least one of the selected N value or the selected Ns value being based at least in part on the at least one of the one or more supported N values or the one or more supported Ns values.

Alternatively, or additionally, based at least in part on the network node being a non-CN network node, the communication manager 155 may relay, as a bypass mechanism, a first non-stratum access (NAS) message from a UE to a core network, the first NAS message comprising a paging support indication that specifies at least one of: one or more supported N values, or one or more supported Ns values; relay, as the bypass mechanism, a second NAS message from the core network to the UE, the second NAS message comprising a paging setup indication that specifies at least one of: a selected N value that is based at least in part on the one or more supported N values, or a selected Ns value that is based at least in part on the one or more supported Ns values; and receive an indication that is directed to the network node, the indication specifying the at least one of the selected N value or the selected Ns value. Additionally, or alternatively, the communication manager 155 may perform one or more other operations described herein.

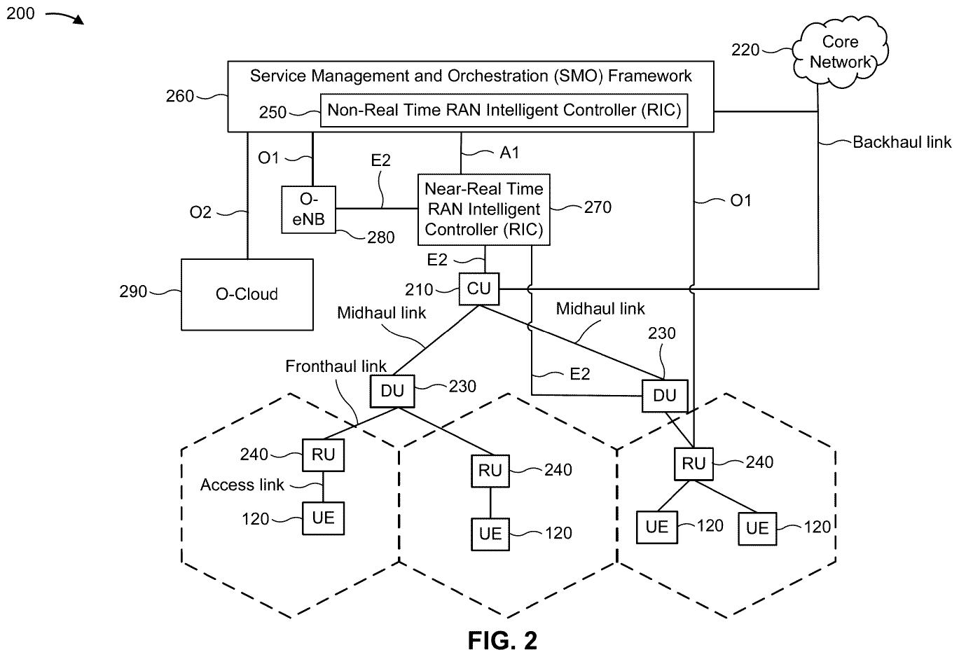

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links.

In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/IL workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

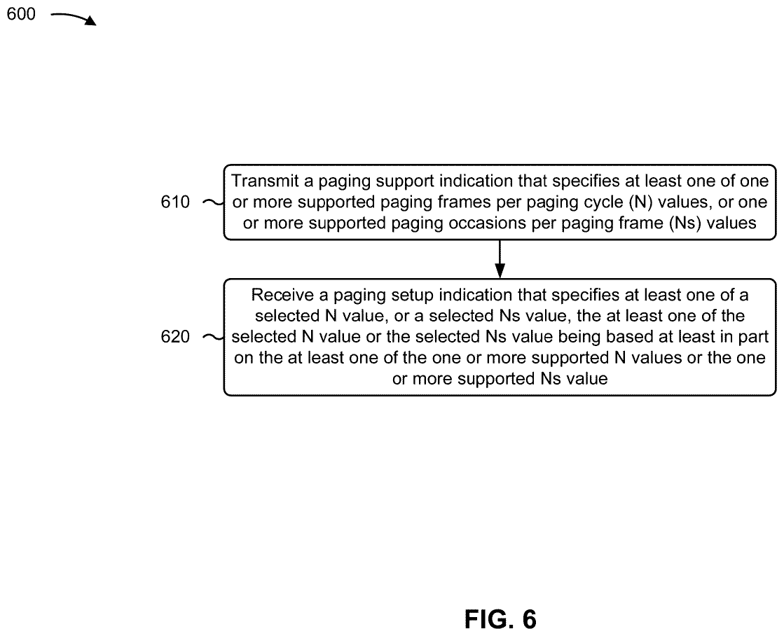

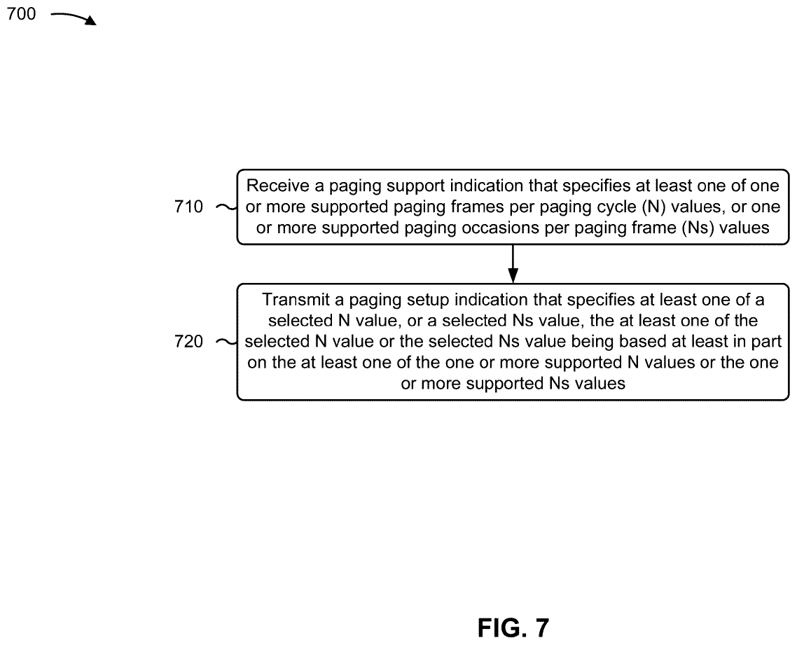

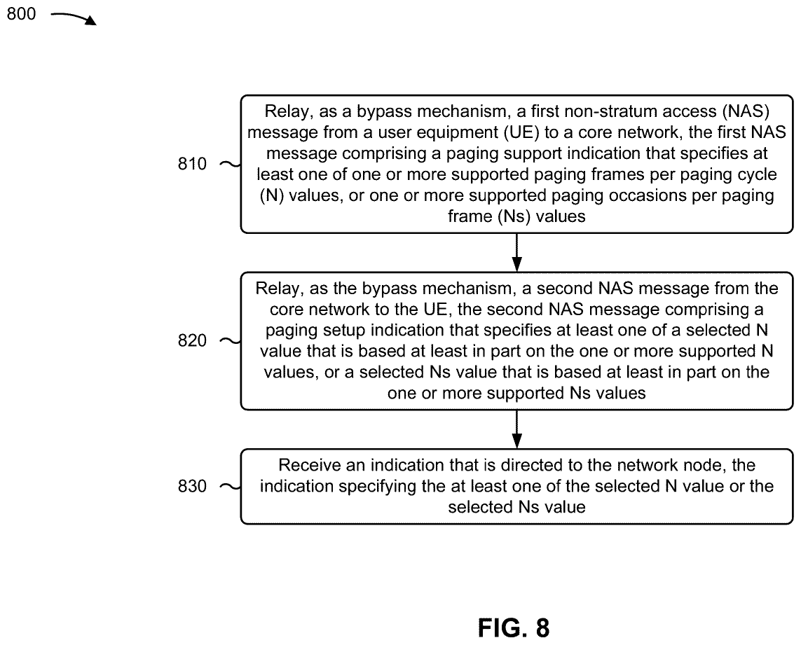

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with a PEI with paging adaptation, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, process 800 of FIG. 8, or other processes as described herein. In some examples, executing instructions may include running the instructions, converting the instructions, compiling the instructions, or interpreting the instructions, among other examples.

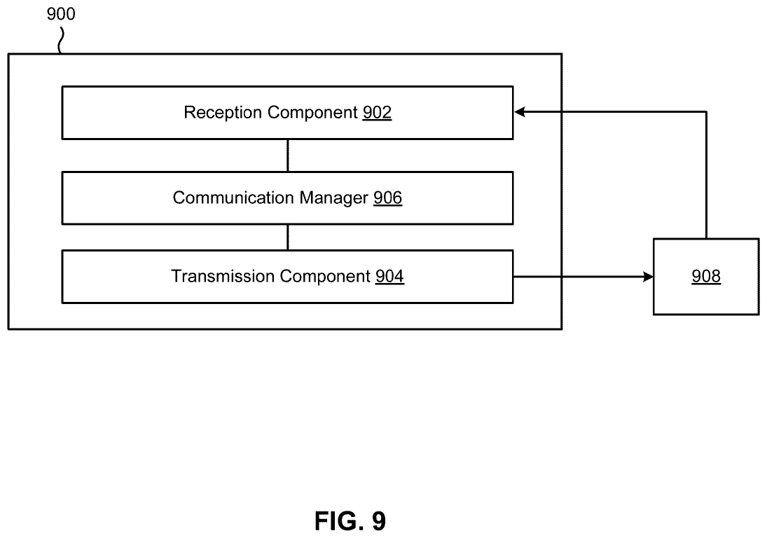

In some aspects, a UE (e.g., a UE 120) includes means for transmitting a paging support indication that specifies at least one of: one or more supported N values, or one or more supported Ns values; and means for receiving a paging setup indication that specifies at least one of: a selected N value, or a selected Ns value, the at least one of the selected N value or the selected Ns value being based at least in part on the at least one of the one or more supported N values or the one or more supported Ns values. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

In some aspects, a network node (e.g., a network node 110 that is a CN network node or a non-CN network node) includes means for receiving a paging support indication that specifies at least one of: one or more supported N values, or one or more supported Ns values; and means for transmitting a paging setup indication that specifies at least one of: a selected N value, or a selected Ns value, the at least one of the selected N value or the selected Ns value being based at least in part on the at least one of the one or more supported N values or the one or more supported Ns values.

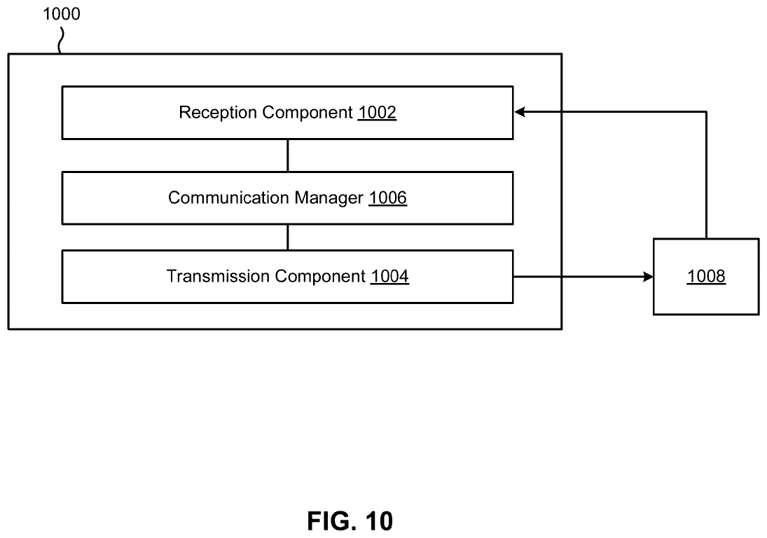

Alternatively, or additionally, the network node (e.g., a network node 110 that is a non-CN network node) includes means for relaying, as a bypass mechanism, a first NAS message from a UE to a core network, the first NAS message comprising a paging support indication that specifies at least one of: one or more supported N values, or one or more supported Ns values; means for relaying, as the bypass mechanism, a second NAS message from the core network to the UE, the second NAS message comprising a paging setup indication that specifies at least one of: a selected N value that is based at least in part on the one or more supported N values, or a selected Ns value that is based at least in part on the one or more supported Ns values; and means for receiving an indication that is directed to the network node, the indication specifying the at least one of the selected N value or the selected Ns value. The means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

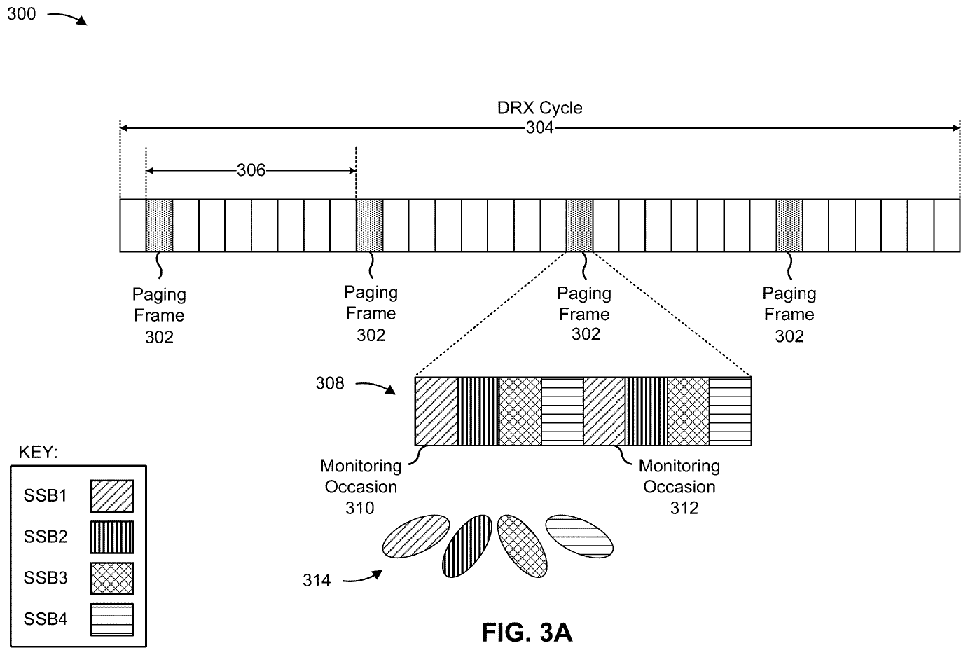

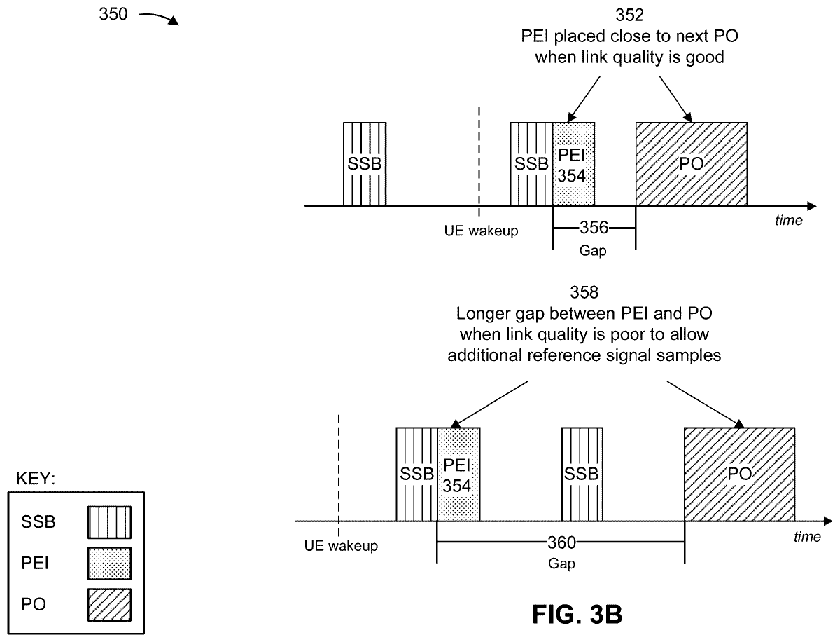

FIGS. 3A-3B are diagrams illustrating a first example 300 and a second example 350, respectively, of paging configurations. The first example 300 shown by FIG. 3A includes paging reception configuration that may be used by a UE (e.g., a UE 120) operating in an idle or inactive mode. In the first example 300, the UE monitors a control channel (e.g., a PDCCH) during a PO within a paging frame, and the UE determines whether a page is scheduled for the UE during the PO. For example, the UE may identify a paging frame 302 within a DRX cycle 304 that is configured for the UE. The paging frame 302 may generally represent a reference frame or a starting frame for a PO associated with the UE, and a PO associated with paging frame 302 may start in the paging frame or after the paging frame based at least in part on multi-beam operation or PO repetition.

A network node (e.g., a network node 110) may configure paging reception for the UE by indicating a number of radio frames in a DRX cycle (e.g., the DRX cycle 304) that may have a cell-specific value or a UE-specific value. In general, a DRX cycle may be configured to include 32, 64, 128, or 256 radio frames, and the network node may configure an interval between adjacent paging frames (e.g., 1, 2, 4, 8, or 16 radio frames) and a time domain offset in frames for paging frames (e.g., from zero to N frames, where Nis an integer that is one less than the interval between adjacent paging frames). In some aspects, a number of paging frames in each DRX cycle may be based at least in part on the number of radio frames and the interval between adjacent paging frames.

In FIG. 3A, the DRX cycle 304 includes 32 radio frames that are 10 milliseconds each, and adjacent paging frames have an inter-paging frame interval 306 that is 8 radio frames (or 80 milliseconds). Accordingly, the DRX cycle 304 includes four (4) paging frames (shown with a dotted pattern). The UE may identify a particular paging frame (e.g., from the four paging frames in the DRX cycle 304) that is associated with the UE, such as by identifying the particular paging frame (e.g., paging frame 302) using an identifier that is assigned to the UE.

As further shown in FIG. 3A, the UE may determine a PO 308 in the paging frame 302 that is associated with the UE, and the UE may monitor the control channel for a paging indication associated with the UE during the PO 308. A network node may configure a number of POs that is included in each paging frame (e.g., 1, 2, or 4 POs per paging frame). In some aspects, the UE may determine a PO index (iₛ) associated with the UE based on the identifier assigned to the UE. To illustrate, each PO may contain a set of S*X consecutive PDCCH monitoring occasions, where S is a number of actual transmitted SSBs indicated in a system information block (SIB) that carries information to enable access to a cell provided by the network node (e.g., a system information block type 1 (SIB1)) and X is a number of PDCCH monitoring occasions per SSB in a PO (e.g., 1, 2, 3, or 4). In the example 300, S=4 (e.g., SSB1 shown with a diagonal stripe, SSB2 shown with a vertical stripe, SSB3 shown with a cross-hatch pattern, and SSB4 shown with a horizontal stripe) and X=2. For example, SSB1 may be transmitted twice in the PO 308, during a first monitoring occasion 310 and a second monitoring occasion 312. As shown by reference number 314, each SSB may be transmitted via a respective beam or respective beam configuration. The starting PDCCH monitoring occasion number of PO is may be configured by the network node, or based on a value of iₛ*S*X, where the [x*S+K-th PDCCH monitoring occasion for paging in the PO corresponds to the K-th transmitted SSB, where x=0, 1, . . . , X−1, and where K=1, 2, . . . , S.

In some aspects, and based at least in part on operating an idle or inactive mode, the UE may wake up from the idle or inactive mode once in every DRX cycle during the PO associated with the UE (e.g., that is determined in the manner described above). At the time that the UE wakes up from the idle or inactive mode, the UE may be unaware of whether there will be a page for the UE during the PO. Consequently, when the UE wakes up during the PO associated with the UE, an entire receive chain is activated to enable the UE to receive and decode a page that may be carried on a PDSCH. This may increase power consumption at the UE, as components needed to receive and decode the paging PDSCH may not need to be activated if there is no page scheduled for the UE.

Accordingly, in some cases, a wireless network may support a PEI, sometimes referred to as a WUS, to improve power efficiency associated with paging reception at a UE. To illustrate, the second example 350 that is shown by FIG. 3B is an example paging configuration that includes the use of a PEI. In some aspects, a PEI (shown with a vertical stripe) is a special signal that a network node (e.g., a network node 110) transmits to a UE (e.g., a UE 120) before a PO (shown with a diagonal stripe) that is associated with the UE, and the PEI may indicate whether the UE should wake up to receive a paging message. In this way, the UE may monitor only a PDCCH to determine whether the network node transmitted a PEI to indicate that the UE is to wake up to receive a paging message, and may return to a low-power state in cases where a PEI is not transmitted or a PEI indicates that there is no page intended for the UE in the associated PO. Alternatively, when the PEI is transmitted to indicate that the UE should wake up to receive a paging message, the UE may fully wake up to receive the PDSCH carrying the paging message. In such cases, after the UE receives a PEI indicating that the UE has a page, the UE may additionally measure one or more reference signals (e.g., one or more SSBs, TRSs, or CSI-RSs) to synchronize with the network node and improve decoding of the PDSCH carrying the paging message.

For example, as shown by reference number 352, a PEI 354 may be placed relatively close in time to the next PO (shown in FIG. 3B as a first gap 356) in cases where the channel between the network node and the UE has a good link quality, as remaining time after the UE processes the reference signal transmissions may not be long enough to merit a transition to deep sleep (e.g., one reference signal sample may be enough to reliably decode the paging PDSCH). Otherwise, as shown by reference number 358, the PEI 354 may be placed further away in time from the PO as shown by a second gap 360 that is longer than the first gap 356. A longer gap or duration as shown by the second gap 360 may be provided between the PEI 354 and the next PO to allow the UE to obtain multiple reference signal samples between the PEI 354 and the next PO when the quality of the channel between the network node and the UE is poor.

In this way, a PEI enables the UE to wake up in two stages, which include a first stage in which the UE activates only a portion of a receive chain to monitor the PDCCH for a PEI and a second stage in which the UE activates a remaining portion of the receive chain to receive and decode the paging PDSCH (or measure or sample reference signals) if the PEI indicates that there is a page for the UE in the associated PO.

As part of an effort to increase NES in a wireless network, a communication standard (e.g., a 3GPP communications standard) may adapt one or more common signal transmissions, one or more channel transmissions, or a combination thereof, in a manner that increases energy savings. Examples may include SSB adaptation in the time domain (e.g., adapt a periodicity of the SSB), a PRACH adaptation in the time domain, and an adaptation of one or more paging occasions. As part of adapting a common signal transmission or a channel transmission, the communication standard may specify the adaptation in a manner that maintains backwards compatibility with a UE that does not implement support for the adaptation (e.g., a legacy UE).

Alternatively, or additionally, the communication may specify the adaptation in a manner that does not increase a latency in a process, such as a paging latency.

As an example of a PO adaptation, a communication standard may initially specify, as part of a paging process between a network node and a UE, a supported value for N, a supported value for Ns, or a combination of the two. An adaptation to the paging process may include introducing an additional supported value for N, an additional supported value for Ns, or a combination of the two. The increase in supported values for N, Ns, or the combination, may lead to a mismatch between when a network node transmits a PEI, and when a UE monitors for the PEI, resulting in the UE failing to receive the PEI.

To illustrate, a wireless communication device (e.g., a network node 110 or a UE 120) may compute a location of a PF using the following equation:

$$PF = \frac{T}{N} \times ( UE\_ID mod N ) ,$$

and may compute a location of a PO index (i_s) within the PF using the equation:

$$i\_s = floor ( \frac{UE\_ID}{N} ) mod {N}_{s}$$

where Tis a paging cycle length for a UE, and may be computed as:

$$T = min \{ \begin{matrix}{UE}^{′} s DRX configured by RRC , \\ {UE}^{′} s DRX configured by upper layer , \\ default DRX\end{matrix} \} .$$

As described above, Nis a number or quantity of paging frames per paging cycle, and Ns is a supported value for a number or quantity of paging occasions per paging frame.

UE_ID is an identifier of the UE that is associated with paging computations as described above. In some cases, the UE_ID may be derived from a subscription permanent identifier (SUPI) or a system temporary mobile subscriber identity (S-TMSI).

A wireless communication device may derive a time location of a PEI-O for a UE using a reference point (e.g., indicated by an RRC configured parameter, such as pei-FrameOffset) that is based at least in part on a starting location of a first PF of one or more PFs that are associated with the PEI-O. Alternatively, or additionally, the time location of a PEI-O for the UE may be derived using an offset value (e.g., indicated by an RRC configured parameter, such asfirstPDCCH-MonitoringOccasionOfPEI-O) from the reference point to a start of a first PDCCH monitoring occasion of the PEI-O. A UE may use the derived time location to monitor for a PEI in the PEI-O. Based at least in part on detecting a PEI in the PEI-O, and detecting that the PEI indicates a subgroup that the UE belongs to for PO monitoring, the UE may monitor for a transmission in the associated PO. Based at least in part on not detecting that the PEI indicates the subgroup associated with the UE, the UE may not monitor the associated PO. In some cases, UEs that share a same PO may be divided into subgroups, and the PEI may indicate subgrouping information that results in a lower group paging rate and fewer false paging alarms.

A first example of UE subgrouping for POs may be subgrouping that is controlled by a CN, also referred to as CN controlled subgrouping. Based at least in part on a UE supporting CN controlled subgrouping, the CN (e.g., via an access and mobility management function (AMF)) may determine a subgroup for a UE and may assign the UE a subgroup identifier (ID) to the UE. In some cases, the CN may be a first network node that communicates the subgroup ID to the UE in NAS messaging through a second network node (e.g., a base station) in a bypass manner. That is, the second network node may be a bypass mechanism that relays the NAS messaging between a CN and a UE without accessing content included in the NAS messaging, such as the subgroup ID. Accordingly, the CN may also communicate the subgroup ID to the second network node using messaging that the second network node accesses (e.g., reads) to enable the second network node to communicate with the UE or transmit paging-related signaling (e.g., a PEI) to the UE based at least in part on the UE operating in an idle state or an inactive state, such as an RRC_IDLE state or an RRC_INACTIVE state.

A second example of UE subgrouping for POs may be UE ID-based subgrouping that is performed by a network node other than a core network, such as a base station. In UE ID-based subgrouping a network node (e.g., a base station) and a UE may determine a subgroup ID for POs that is assigned to a UE using a UE ID that is assigned to the UE (or may be derived as described above). A total number of possible subgroups for UE ID-based subgrouping may be determined by a network operator or a network node that provides a cell. That is, the total number of possible subgroups may differ from cell to cell.

Independent of a type of UE subgrouping used for POs, a particular release of the communication standard may include multiple adaptations, such as the SSB adaptation, the PRACH adaptation, and the PO adaptation described above. For some scenarios, a UE may indicate support for the particular release with more than one features, but only support a first feature of the particular release (e.g., the SSB adaptation and the PRACH adaptation). That is, the UE may indicate support for the particular release without including support a second feature of the particular release (e.g., the PO adaptation). In indicating support for the particular release, the UE may not communicate the lack of support for a second portion of the adaptations, potentially resulting in a mismatch between timing used by a network node to transmit a PEI and timing used by a UE to receive the PEI and the UE failing to detect or receive a PEI that is directed to the UE. For instance, the UE may not include support for the additional supported value for N, the additional supported value for Ns, or a combination of the two, and the network node may use the additional supported value for N, the additional supported value for Ns, or a combination of the two to compute a PF location, a PO location, a PEI-O location, or any combination thereof. Conversely, the UE may use initial supported values for N, Ns, or a combination thereof, to compute the PF location, the PO location, or the PEI-O location, resulting in a timing mismatch. Alternatively, or additionally, the network node and the UE may derive a different PO subgroup assignment for UE, also resulting in the UE not detecting or receiving a PEI that is directed to the UE.

Various aspects relate generally to a PEI with paging adaptation. Some aspects more specifically relate to signaling that enables a network node and a UE to synchronize or align computations that are used to derive paging related locations, such as a PF location, a PO location, a PEI-O location, or any combination thereof. In some aspects, a UE may transmit a paging support indication that specifies at least one of: one or more supported N values, or one or more supported Ns values. As one example, the UE may indicate support for one or more communication standard specified N values that are supported by the UE, one or more communication standard specified Ns values that are supported by the UE, or any combination of the two. The UE may receive a paging setup indication that specifies at least one of: a selected N value, or a selected Ns value. The selected N value or the selected Ns value may be selected by a CN, or a non-CN network node. In some aspects, the selected N value, the selected Ns value, or any combination, may be based at least in part on the supported N value(s), the supported Ns value(s), or any combination thereof, that are indicated by the UE.

In some aspects, a network node (e.g., a CN network node or a non-CN network node) may receive a paging support indication that specifies at least one of: one or more supported N values, or one or more supported Ns values. The supported N values, the supported Ns values, or any combination thereof, may be specific to a particular UE. Based at least in part on receiving the paging support indication, the network node may transmit a paging setup indication that specifies at least one of: a selected N value, or a selected Ns value. In some aspects, the network node may choose the selected N value, the selected Ns value, or both from the supported N value(s), the supported Ns value(s), or both.

Particular aspects of the subject matter described in this disclosure can be implemented to realize one or more of the following potential advantages. In some examples, by a UE indicating any combination of supported N value(s) or supported Ns value(s), the described techniques can be used to enable a network node (e.g., a CN network node or a non-CN network node) to choose or select an N value, an Ns value, or any combination in a manner that maintains synchronization with the UE.

Alternatively, or additionally, the network node may transmit an indication of the selected N value, the selected Ns value, or any combination thereof, to mitigate a mismatch with the UE with regards to deriving paging related locations (e.g., a PF location, a PO location, or a PEI-O location), deriving a PO subgroup assignment to the UE, or a combination of the two. Mitigating a mismatch in deriving paging related locations or driving the PO subgroup assignment to the UE may enable a network node to transmit a PEI using timing and information that is expected by the UE, resulting in the UE detecting and receiving a PEI that is directed to the UE.

As indicated above, FIGS. 3A and 3B are provided as examples. Other examples may differ from what is described with regard to FIGS. 3A and 3B.

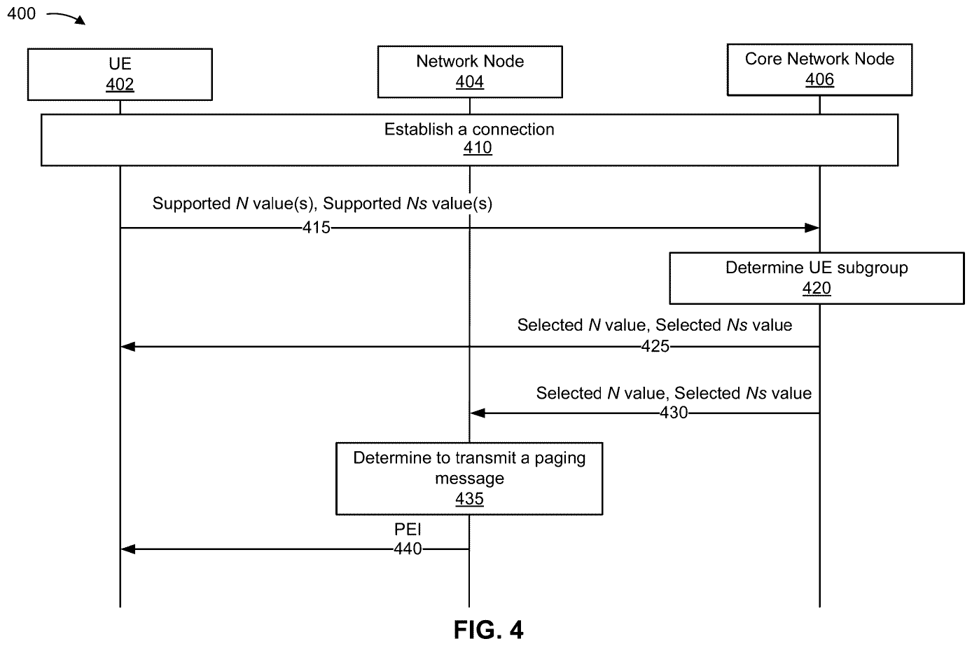

FIG. 4 is a diagram illustrating an example 400 of a wireless communication process between a UE 402 (e.g., a UE 120), a network node 404 (e.g., a first network node 110 not in a core network), and a core network node 406 (e.g., a second network node 110 in a core network. The network node 404 may communicate with the core network node 406 to provide wireless network access to the UE 402. In some aspects, the network node 404 may provide radio access (e.g., via transmit and receive capabilities) to the UE 402, and the core network node 406 may provide control and data management functions to the UE 402. The core network node 406 may communicate with the UE 402 through the network node 404.

As shown by reference number 410, a UE 402, a network node 404, and a core network node 406 may establish a connection. To illustrate, the UE 402 may power up in a cell coverage area provided by the network node 404 in combination with the core network node 406, and the UE 402 and the network node 404 may perform one or more procedures (e.g., a random access channel (RACH) procedure or an RRC procedure) to establish a wireless connection. The network node 404 may communicate with the core network node 406 as at least part of establishing the wireless connection with the UE 402. As another example, the UE 402 may move into the cell coverage area provided by the network node 404 and may perform a handover from a source network node (e.g., another network node 110) to the network node 404, and the core network node 406 may manage one or more aspects of the handover. Alternatively, or additionally, the network node 404 and the UE 402 may communicate via the connection based at least in part on any combination of Layer 1 signaling (e.g., DCI or UCI), Layer 2 signaling (e.g., a MAC-CE), or Layer 3 signaling (e.g., RRC signaling). To illustrate, the network node 404 may request, via RRC signaling, UE capability information or the UE 402 may transmit, via RRC signaling, the UE capability information. As part of communicating via the connection, the network node 404 may transmit configuration information via Layer 3 signaling (e.g., RRC signaling), and activate or deactivate a particular configuration via Layer 2 signaling (e.g., a MAC-CE) or Layer 1 signaling (e.g., DCI). To illustrate, the network node 404 may transmit the configuration information via Layer 3 signaling at a first point in time associated with the UE 120 being tolerant of communication delays, and the network node 110 may transmit an activation of the configuration via Layer 2 signaling or Layer 1 signaling at a second point in time associated with the UE 402 being less tolerant of communication delays.

As shown by reference number 415, the UE 402 may transmit, and the core network node 406 may receive by way of the network node 404, a paging support indication, and the paging support indication may specify one or more supported N values, one or more supported Ns values, or any combination thereof. That is, the UE 402 may transmit a paging support indication that indicates the N value(s), the Ns value(s), or a combination of both, that are supported by the UE 402. As an example, the UE 402 may transmit the paging support indication in a NAS message that is directed to the core network node 404. The network node 404 may receive the NAS message that includes the paging support indication and may relay the NAS message to the core network 404 as a bypass mechanism. That is, the network node 404 may receive the NAS message from the UE 402 and may forward the NAS message to the core network node 406 without reading or decoding the content of the NAS message (e.g., without reading or decoding the paging support indication).

In some aspects, the UE 402 may transmit the paging support indication as at least part of signaling that indicates the UE 402 supports CN controlled subgrouping of UEs for POs as described with regard to FIG. 4. To illustrate, the UE 402 may transmit NAS signaling that indicates the UE 402 supports CN controlled subgrouping (e.g., a CN controlled subgrouping support indication) and, as at least part of the NAS signalling, the CN controlled subgrouping support indication, or both, the UE 402 may indicate or include the N value(s), the Ns value(s), or a combination of both, that are supported by the UE 402. For instance, the UE 402 may transmit a “UE radio capability for paging” information element (IE), and may indicate in the IE support for CN controlled subgrouping, one or more supported N values, one or more supported Ns values, or any combination thereof. In some aspects, a NAS message that carries a CN controlled subgrouping support indication and does not indicate any supported N values or any supported Ns values may indicate that the associated UE does not include support for adapted values of N and Ns (e.g., the values for paging adaptation). In some aspects, a NAS message that carries a CN controlled subgrouping support indication and indicate only the adapted values of N and Ns (e.g., the values for paging adaptation) may indicate that the associated UE does not include support for non-adapted values of N and Ns (e.g., the values not for paging adaptation).

As shown by reference number 420, the core network node 406 may determine a UE subgroup for the UE 402, such as a PO subgroup to assign to the UE 402. As one example, the core network node 406 (e.g., via an AMF at the core network node 406) may choose a selected N value, a selected Ns value, or a combination of the two, from the supported N value(s) indicated by the UE 402, the supported Ns value(s) indicated by the UE 402, or both. In some examples, the selected N value, the selected Ns value, or a combination of the two, may be value(s) that are supported by a first UE that does not include support for the paging adaptation. In other examples, the selected N value, the selected Ns value, or a combination of the two may be value(s) that are supported by a second UE that does include support for the paging adaptation. The core network node 406 may may compute a PF and a PO within the PF based on the selected N value, or the selected Ns value as described with regard to FIG. 3. Additionally, or alternatively, the core network node 406 may derive a UE subgroup associated with the UE 402 based on the PF and/or a PO within the PF (e.g., derive one or more UE subgroups for the UEs sharing the same PO within the PF). That is the PF and the PO within the PF may inherently or implicitly associate a UE subgroup to assign to the UE 402 (e.g., based on the number of UEs sharing the same PO within the PF, for example, fewer UE subgroups with fewer UEs sharing the same PO within the PF or more UE subgroups with more UEs sharing the same PO within the PF).

As shown by reference number 425, the core network node 406 may transmit, by way of the network node 404, and the UE 402 may receive, a paging setup indication, and the paging setup indication may specify a selected N value, a selected Ns value, or both. As an example, the core network node 406 may communicate a NAS message that includes or indicates the paging setup indication that specifies one or more of a selected N value or a selected Ns. To illustrate, the core network node 406 may communicate a NAS message that indicates a subgroup identifier assignment for the UE 402, and the NAS message may also include or indicate the selected N value, a selected Ns value, or both. The network node 404 may receive and relay the NAS message to the UE 402 as a bypass mechanism in a similar manner as described with regard to reference number 415.

As shown by reference number 430, the core network node 406 may communicate, and the network node 404 may receive, an indication of the selected N value, the selected Ns value, or both. For instance, the core network node 406 may communicate the indication of the selected N value, the selected Ns value, or both, using a next generation (NG) interface and in a message that is directed to the network node 404. For example, the core network 404 may communicate a message that indicates a CN assigned subgroup identifier to use for paging the UE 402 in scenarios where the UE 402 operates in an idle state or an inactive state, and the message may include the selected N value, the selected Ns value, or both.

As shown by reference number 435, the network node 404 may determine to transmit a paging message that is directed to the UE 402. For instance, the network node 404 may receive a paging message indication, such as from an AMF at the core network node 406, that indicates to transmit a paging message to the UE 402. In some aspects, the core network node 406 may indicate a paging message to transmit to the UE 402, and in other aspects, the network node 404 may derive the paging message based at least in part on receiving the paging message indication. The network node 404 may derive a PO associated with UE 402 using one or more of the selected N value, the selected Ns value, or the UE ID associated with the UE 402 based at least in part on the paging message indication being directed to the UE 402. Alternatively, or additionally, the network node 404 may derive a UE subgroup (e.g., a CN controlled subgroup of the UE) that is associated with transmitting a PEI that is directed to the UE 402 using a UE subgroup identifier assigned to the UE 402.

As shown by reference number 440, the network node 404 may transmit, and the UE 402 may receive, a PEI. The network node 404 may transmit, and the UE 402 may receive, the PEI occasion using the selected N, the selected Ns, or a combination of both, resulting in synchronized PEI transmission and PEI reception. In some aspects, the PEI may indicate the UE subgroup derived by the network node 404 as described with regard to reference number 435. The network node 404 may subsequently transmit a paging message in the associated PO based on the UE subgroup indicated via the PEI.

A UE indicating any combination of supported N value(s) or supported Ns value(s), may enable a network node (e.g., a CN network node) to choose or select an N value, an Ns value, or any combination that is supported by the UE and maintain synchronization with the UE. Alternatively, or additionally, the network node may transmit an indication of the selected N value, the selected Ns value, or any combination thereof, to mitigate a mismatch with the UE with regards to deriving paging related locations (e.g., a PF location, a PO location, or a PEI-O location), deriving a PO subgroup assignment to the UE, or a combination of the two. Mitigating a mismatch in deriving paging related locations or driving the PO subgroup assignment to the UE may enable a network node to transmit a PEI using timing and information that is expected by the UE, resulting in the UE detecting and receiving a PEI that is directed to the UE.

As indicated above, FIG. 4 is provided as an example. Other examples may differ from what is described with regard to FIG. 4.

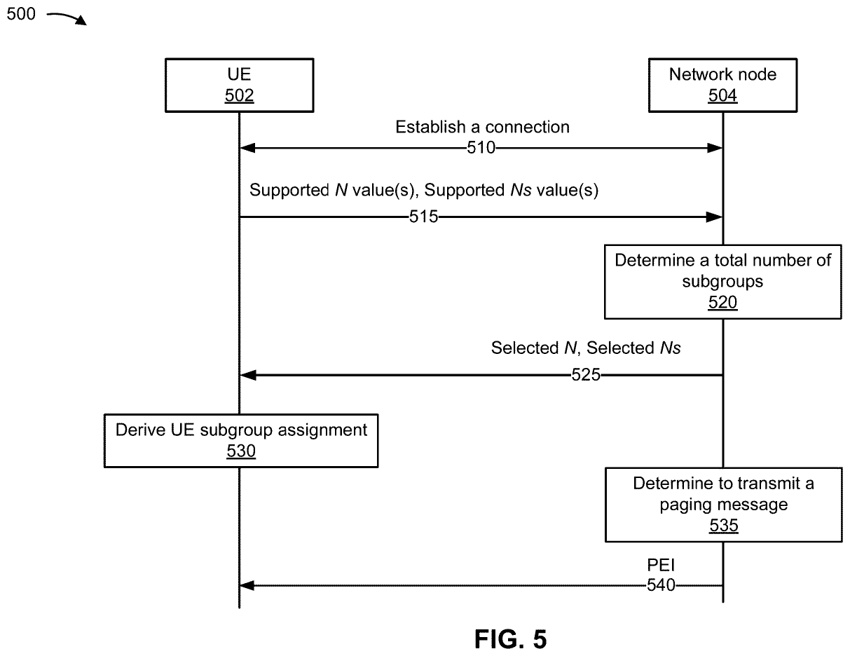

FIG. 5 is a diagram illustrating an example 500 of a wireless communication process between a UE 502 (e.g., a UE 120) and a network node 504 (e.g., a network node 110).

As shown by reference number 510, a UE 502 and a network node 504 may establish a connection. As an example, the UE 502 and the network node 504 may establish a connection with one another in a similar manner as the UE 402 and the network node 404 as described with regard to FIG. 4. In establishing a connection with the UE 502, the network node 504 may communicate with a core network.

As shown by reference number 515, the UE 502 may transmit, and the network node 504 may receive, a paging support indication, and the paging support indication may specify one or more supported N values, one or more supported Ns values, or any combination thereof. In some aspects, the UE 502 may transmit the paging support indication in RRC signaling that is directed to the network node 504. As one example, the UE 502 may transmit the paging support indication in a message that indicates the UE 502 supports UE identifier-based subgrouping (e.g., the UE 502 may transmit a UE identifier-based subgrouping support indication). To illustrate, the UE 502 may transmit the UE identifier-based subgrouping support indication and, consequently, the paging support indication, as at least part of UE capability information. As another example, the UE 502 may transmit the UE identifier-based subgrouping support indication and, consequently, the paging support indication, as at least part of UE assistance information. Accordingly, the UE 502 may indicate the supported N value(s), the supported Ns values, or any combination thereof, in UE capability information or UE assistance information.

For clarity, FIG. 5 illustrates the UE 502 transmitting the paging support indication in a separate transaction from establishing a connection with the network node 504. However, in some aspects, the UE 502 may transmit the paging support indication (and any combination of the supported N value(s) or the supported Ns values) as part of establishing a connection with the network node 504.

As shown by reference number 520, the network node 504 may determine a total number of subgroups for a UE identifier-based subgrouping for a cell provided by the network node 504. In some aspects, the network node 504 may compute the total number of subgroups based at least in part on the supported N value(s) indicated by the UE 502, the supported Ns value(s) indicated by the UE 502, or both (e.g., based on the number of UEs sharing a same PO within a PF).

As one example, network node 504 may choose a selected N value, a selected Ns value, or a combination of the two, from the supported N value(s) indicated by the UE 502, the supported Ns value(s) indicated by the UE 502, or both. In some examples, the selected N value, the selected Ns value, or a combination of the two, may be value(s) that are supported by a first UE that does not include support for the paging adaptation. In other examples, the selected N value, the selected Ns value, or a combination of the two may be value(s) that are supported by a second UE that does include support for the paging adaptation. Accordingly, the network node 504 may choose the selected N value, the selected Ns value, or a combination of the two, using the supported N value(s) indicated by the UE 502, the supported Ns value(s) indicated by the UE 502, or a combination of the two. The network node 504 may then use the selected N value, the selected Ns value, or a combination of the two, to determine the total number of subgroups for UE identifier-based subgrouping, and the total number of subgroups for UE identifier-based subgrouping may be associated with one or more POs. For example, with many UEs sharing the same PO, the false paging alarm rate may be high.

Dividing the UEs of one PO in multiple sub-groups may minimize the false paging alarm (e.g., more UE subgroups with more UEs sharing a same PO within a PF to reduce the paging false alarm). That is the total number of UE subgroups may be a function of a total number of PFs, a total number of POs per PF, and the selected Ns.

As shown by reference number 525, the network node 504 may transmit, and the UE 502 may receive, a paging setup indication, and the paging setup indication may specify a selected N value, a selected Ns value, or both. As one example, the network node 504 may transmit the paging setup indication in broadcast signaling, such as by including the paging setup indication and, consequently, a selected N value, a selected Ns value, or both, in system information, such as a SIB1. Alternatively, or additionally, the network node 504 may transmit, in the broadcast signaling, an indication of the total number of subgroups for UE identifier-based subgrouping that is determined by the network node 504 as described with regard to reference number 520, and may indicate the paging setup indication in the signaling that carries the indication of the total number of subgroups for UE identifier-based subgrouping.

As shown by reference number 530, the UE 502 may derive a UE subgroup assignment. For instance, the UE 502 may use the selected N value, the selected Ns value, a UE ID assigned to the UE 502, or any combination, to derive the UE subgroup assignment for POs. As described above, the UE 502 may derive the UE ID from UE ID may be derived from an SUPI or an S-TMSI. In some examples, the UE subgroup assignment may be derived by performing a modulo operation on the UE ID with the selected Ns value.

As shown by reference number 535, the network node 504 may determine to transmit a paging message. As one example, the network node 504 may determine to transmit the paging message in a similar manner as described with regard to reference number 435 in the example 400.

As shown by reference number 540, the network node 504 may transmit, and the UE 502 may receive, a PEI. To illustrate, the network node 504 may transmit the PEI in a similar manner as described with regard to reference number 440 in the example 400. The network node 504 may subsequently transmit a paging message in the associated PO.

A UE indicating any combination of supported N value(s) or supported Ns value(s), may enable a network node to choose or select an N value, an Ns value, or any combination that is supported by the UE and maintain synchronization with the UE. Alternatively, or additionally, the network node may transmit an indication of the selected N value, the selected Ns value, or any combination thereof, to mitigate a mismatch with the UE with regards to deriving paging related locations (e.g., a PF location, a PO location, or a PEI-O location), deriving a PO subgroup assignment to the UE, or a combination of the two. Mitigating a mismatch in deriving paging related locations or driving the PO subgroup assignment to the UE may enable a network node to transmit a PEI using timing and information that is expected by the UE, resulting in the UE detecting and receiving a PEI that is directed to the UE.

As indicated above, FIG. 5 is provided as an example. Other examples may differ from what is described with regard to FIG. 5.

FIG. 6 is a diagram illustrating an example process 600 performed, for example, at a UE or an apparatus of a UE. Example process 600 is an example where the apparatus or the UE (e.g., UE 120) performs operations associated with PEI with paging adaptation.

As shown in FIG. 6, in some aspects, process 600 may include transmitting a paging support indication that specifies at least one of: one or more supported N values, or one or more supported Ns values (block 610). For example, the UE (e.g., using transmission component 904 or communication manager 906, depicted in FIG. 9) may transmit a paging support indication that specifies at least one of: one or more supported N values, or one or more supported Ns values, as described above.

As further shown in FIG. 6, in some aspects, process 600 may include receiving a paging setup indication that specifies at least one of: a selected N value, or a selected Ns value, the at least one of the selected N value or the selected Ns value being based at least in part on the at least one of the one or more supported N values or the one or more supported Ns values (block 620). For example, the UE (e.g., using reception component 902 or communication manager 906, depicted in FIG. 9) may receive a paging setup indication that specifies at least one of: a selected N value, or a selected Ns value, the at least one of the selected N value or the selected Ns value being based at least in part on the at least one of the one or more supported N values or the one or more supported Ns values, as described above.

Process 600 may include additional aspects, such as any single aspect or any combination of aspects described below or in connection with one or more other processes described elsewhere herein.

In a first aspect, process 600 includes deriving a paging occasion location based at least in part on the at least one of the selected N value or the selected Ns value, and receiving a PEI that is directed to the UE based at least in part on the paging occasion.

In a second aspect, transmitting the paging support indication includes transmitting the paging support indication as at least part of a core network controlled subgroup support indication.

In a third aspect, transmitting the paging support indication includes transmitting the paging support indication in a NAS message.

In a fourth aspect, receiving the paging setup indication includes receiving the paging setup indication in a NAS message.

In a fifth aspect, receiving the paging setup indication includes receiving the paging setup indication in subgroup identifier assignment signaling.

In a sixth aspect, transmitting the paging support indication includes transmitting the paging support indication in RRC signaling.

In a seventh aspect, transmitting the paging support indication includes transmitting the paging support indication as at least part of a UE identifier-based subgrouping support indication.

In an eighth aspect, transmitting the paging support indication includes transmitting the paging support indication as at least part of UE capability information.

In a ninth aspect, transmitting the paging support indication includes transmitting the paging support indication as at least part of UE assistance information.

In a tenth aspect, receiving the paging setup indication includes receiving the paging setup indication in broadcast signaling.

In an eleventh aspect, receiving the paging setup indication includes receiving the paging setup indication as at least part of signaling that indicates a total number of subgroups for UE identifier-based subgrouping in a cell.

In a twelfth aspect, the paging setup indication is associated with one or more UE subgroups, and the one or more UE subgroups are associated with a paging occasion.

In a thirteenth aspect, process 600 includes deriving a UE subgroup using a UE identifier.

In a fourteenth aspect, process 600 includes deriving a UE subgroup using selected N value and the selected Ns value.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated PEI with paging adaptation.

As shown in FIG. 7, in some aspects, process 700 may include receiving a paging support indication that specifies at least one of: one or more supported N values, or one or more supported Ns values (block 710). For example, the network node (e.g., using reception component 1002 or communication manager 1006, depicted in FIG. 10) may receive a paging support indication that specifies at least one of: one or more supported N values, or one or more supported Ns values, as described above.

As further shown in FIG. 7, in some aspects, process 700 may include transmitting a paging setup indication that specifies at least one of: a selected N value, or a selected Ns value, the at least one of the selected N value or the selected Ns value being based at least in part on the at least one of the one or more supported N values or the one or more supported Ns values (block 720). For example, the network node (e.g., using transmission component 1004 or communication manager 1006, depicted in FIG. 10) may transmit a paging setup indication that specifies at least one of: a selected N value, or a selected Ns value, the at least one of the selected N value or the selected Ns value being based at least in part on the at least one of the one or more supported N values or the one or more supported Ns values, as described above.

Process 700 may include additional aspects, such as any single aspect or any combination of aspects described below or in connection with one or more other processes described elsewhere herein.

In a first aspect, receiving the paging support indication includes receiving the paging support indication in a NAS message.

In a second aspect, receiving the paging support indication includes receiving the paging support indication as at least part of a core network controlled subgroup support indication.

In a third aspect, transmitting the paging setup indication includes transmitting the paging setup indication in a NAS message.

In a fourth aspect, the paging setup indication is a first paging setup indication that is directed to a UE, the network node is a first network node, and process 700 includes transmitting a second paging setup indication that is directed to a second network node, the second paging setup indication specifying the at least one of the selected N value or the selected Ns value that is based at least in part on the one or more supported Ns values.

In a fifth aspect, transmitting the paging setup indication includes transmitting the paging setup indication in subgroup identifier assignment signaling.

In a sixth aspect, process 700 includes choosing the at least one of the selected N value or the selected Ns value from the at least one of the one or more supported N values or the one or more supported Ns values.

In a seventh aspect, receiving the paging support indication includes receiving the paging support indication in RRC signaling.

In an eighth aspect, receiving the paging support indication includes receiving the paging support indication as at least part of a user equipment identifier-based subgrouping support indication.

In a ninth aspect, receiving the paging support indication includes receiving the paging support indication as at least part of UE assistance information.

In a tenth aspect, receiving the paging support indication includes receiving the paging support indication as at least part of UE capability information.

In an eleventh aspect, transmitting the paging setup indication includes transmitting the paging setup indication in broadcast signaling.

In a twelfth aspect, transmitting the paging setup indication includes transmitting the paging setup indication as at least part of signaling that indicates a total number of subgroups for UE identifier-based subgrouping in a cell.

In a thirteenth aspect, the paging setup indication is associated with one or more UE subgroups, and the one or more UE subgroups are associated with a paging occasion.

In a fourteenth aspect, process 700 includes receiving a paging message indication, deriving a paging occasion associated with the paging message indication based at least in part on the at least one of the selected N value or the selected Ns value, and transmitting a PEI based at least in part on the paging occasion.

In a fifteenth aspect, process 700 includes deriving a UE subgroup associated with the PEI based at least in part on a UE identifier, and the PEI indicates the UE subgroup.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node. Example process 800 is an example where the apparatus or the network node (e.g., network node 110) performs operations associated PEI with paging adaptation.

As shown in FIG. 8, in some aspects, process 800 may include relaying, as a bypass mechanism, a first NAS message from a UE to a core network, the first NAS message including a paging support indication that specifies at least one of: one or more supported N values, or one or more supported Ns values (block 810). For example, the network node (e.g., using communication manager 1006, depicted in FIG. 10) may relay, as a bypass mechanism, a first NAS message from a UE to a core network, the first NAS message including a paging support indication that specifies at least one of: one or more supported N values, or one or more supported Ns values, as described above.

As further shown in FIG. 8, in some aspects, process 800 may include relaying, as the bypass mechanism, a second NAS message from the core network to the UE, the second NAS message including a paging setup indication that specifies at least one of: a selected N value that is based at least in part on the one or more supported N values, or a selected Ns value that is based at least in part on the one or more supported Ns values (block 820). For example, the network node (e.g., using communication manager 1006, depicted in FIG. 10) may relay, as the bypass mechanism, a second NAS message from the core network to the UE, the second NAS message including a paging setup indication that specifies at least one of: a selected N value that is based at least in part on the one or more supported N values, or a selected Ns value that is based at least in part on the one or more supported Ns values, as described above.

As further shown in FIG. 8, in some aspects, process 800 may include receiving an indication that is directed to the network node, the indication specifying the at least one of the selected N value or the selected Ns value (block 830). For example, the network node (e.g., using reception component 1002 or communication manager 1006, depicted in FIG. 10) may receive an indication that is directed to the network node, the indication specifying the at least one of the selected N value or the selected Ns value, as described above.

Process 800 may include additional aspects, such as any single aspect or any combination of aspects described below or in connection with one or more other processes described elsewhere herein.

In a first aspect, receiving the indication that is directed to the network node includes receiving the indication as at least part of a message that indicates an assigned subgroup identifier that is associated with the UE.

In a second aspect, process 800 includes receiving a paging message indication that is directed to the UE, deriving a paging occasion associated with the paging message indication based at least in part on the at least one of the selected N value or the selected Ns value, and transmitting a PEI based at least in part on the paging occasion.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication.

The apparatus 900 may be a UE, or a UE may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 3B-5. Additionally, or alternatively, the apparatus 900 may be configured to perform one or more processes described herein, such as process 600 of FIG. 6, or a combination thereof. In some aspects, the apparatus 900 or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit a paging support indication that specifies at least one of one or more supported N values, or one or more supported Ns values. The reception component 902 may receive a paging setup indication that specifies at least one of a selected N value, or a selected Ns value, the at least one of the selected N value or the selected Ns value being based at least in part on the at least one of the one or more supported N values or the one or more supported Ns values.

The communication manager 906 may derive a PO location based at least in part on the at least one of the selected N value or the selected Ns value. In some aspects, the reception component 902 may receive a PEI that is directed to the UE based at least in part on the PO.

The communication manager 906 may derive a UE subgroup using a UE identifier. Alternatively, or additionally, the communication manager 906 may derive a UE subgroup using selected N value and the selected Ns value.

The number and arrangement of components shown in FIG. 9 are provided as an example. In practice, there may be additional components, fewer components, different components, or differently arranged components than those shown in FIG. 9.

Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node (e.g., a network node 110, a CN network node 110, or a non-CN network node 110), or a network node (e.g., a network node 110, a CN network node 110, or a non-CN network node 110) may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 3B-5. Additionally, or alternatively, the apparatus 1000 may be configured to perform one or more processes described herein, such as process 700 of FIG. 7, process 800 of FIG. 8, or a combination thereof. In some aspects, the apparatus 1000 or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 or the transmission component 1004 may include or may be included in a network interface. The network interface may be configured to obtain or output signals for the apparatus 1000 via one or more communications links, such as a backhaul link, a midhaul link, or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The reception component 1002 may receive a paging support indication that specifies at least one of one or more supported N values, or one or more supported Ns values. The transmission component 1004 may transmit a paging setup indication that specifies at least one of a selected N value, or a selected Ns value, the at least one of the selected N value or the selected Ns value being based at least in part on the at least one of the one or more supported N values or the one or more supported Ns values. The communication manager 1006 may choose the at least one of the selected N value or the selected Ns value from the at least one of the one or more supported N values or the one or more supported Ns values.

In some aspects, the reception component 1002 may receive a paging message indication. Alternatively, or additionally, the communication manager 1006 may derive a PO associated with the paging message indication based at least in part on the at least one of the selected N value or the selected Ns value.

The transmission component 1004 may transmit a PEI based at least in part on the PO. Alternatively, or additionally, the communication manager 1006 may derive a UE subgroup associated with the PEI based at least in part on a UE identifier and the PEI indicates the UE subgroup.

Based at least in part on the apparatus 1000 being a non-CN network node, or a non-CN network node including the apparatus 1000, the communication manager 1006 may relay, as a bypass mechanism, a first NAS message from a UE to a core network, the first NAS message including a paging support indication that specifies at least one of one or more supported N values, or one or more supported Ns values. The communication manager 1006 may relay, as the bypass mechanism, a second NAS message from the core network to the UE, the second NAS message including a paging setup indication that specifies at least one of a selected N value that is based at least in part on the one or more supported N values, or a selected Ns value that is based at least in part on the one or more supported Ns values. The reception component 1002 may receive an indication that is directed to the network node, the indication specifying the at least one of the selected N value or the selected Ns value.

The reception component 1002 may receive a paging message indication that is directed to the UE. The communication manager 1006 may derive a PO associated with the paging message indication based at least in part on the at least one of the selected N value or the selected Ns value. Alternatively, or additionally, the transmission component 1004 may transmit a PEI based at least in part on the PO.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: transmitting a paging support indication that specifies at least one of: one or more supported paging frames per paging cycle (N) values, or one or more supported paging occasions per paging frame (Ns) values; and receiving a paging setup indication that specifies at least one of: a selected N value, or a selected Ns value, the at least one of the selected N value or the selected Ns value being based at least in part on the at least one of the one or more supported N values or the one or more supported Ns values.

Aspect 2: The method of Aspect 1, further comprising: deriving a paging occasion location based at least in part on the at least one of the selected N value or the selected Ns value; and receiving a paging early indication (PEI) that is directed to the UE based at least in part on the paging occasion.

Aspect 3: The method of any of Aspects 1-2, wherein transmitting the paging support indication comprises: transmitting the paging support indication as at least part of a core network controlled subgroup support indication.

Aspect 4: The method of Aspect 3, wherein transmitting the paging support indication comprises: transmitting the paging support indication in a non-access stratum (NAS) message.

Aspect 5: The method of any of Aspects 1-4, wherein receiving the paging setup indication comprises: receiving the paging setup indication in a non-access stratum (NAS) message.

Aspect 6: The method of Aspect 5, wherein receiving the paging setup indication comprises: receiving the paging setup indication in subgroup identifier assignment signaling.

Aspect 7: The method of any of Aspects 1-6, wherein transmitting the paging support indication comprises: transmitting the paging support indication in radio resource control (RRC) signaling.

Aspect 8: The method of Aspect 7, wherein transmitting the paging support indication comprises: transmitting the paging support indication as at least part of a UE identifier-based subgrouping support indication.

Aspect 9: The method of Aspect 7, wherein transmitting the paging support indication comprises: transmitting the paging support indication as at least part of UE capability information.

Aspect 10: The method of Aspect 7, wherein transmitting the paging support indication comprises: transmitting the paging support indication as at least part of UE assistance information.

Aspect 11: The method of any of Aspects 1-10, wherein receiving the paging setup indication comprises: receiving the paging setup indication in broadcast signaling.

Aspect 12: The method of Aspect 11, wherein receiving the paging setup indication comprises: receiving the paging setup indication as at least part of signaling that indicates a total number of subgroups for UE identifier-based subgrouping in a cell.

Aspect 13: The method of any of Aspects 1-12, wherein the paging setup indication is associated with one or more UE subgroups, and wherein the one or more UE subgroups are associated with a paging occasion.

Aspect 14: The method of Aspect 13, further comprising: deriving a UE subgroup using a UE identifier.

Aspect 15: The method of Aspect 13, further comprising: deriving a UE subgroup using selected N value and the selected Ns value.

Aspect 16: A method of wireless communication performed by a network node, comprising: receiving a paging support indication that specifies at least one of: one or more supported paging frames per paging cycle (N) values, or one or more supported paging occasions per paging frame (Ns) values; and transmitting a paging setup indication that specifies at least one of: a selected N value, or a selected Ns value, the at least one of the selected N value or the selected Ns value being based at least in part on the at least one of the one or more supported N values or the one or more supported Ns values.

Aspect 17: The method of Aspect 16, wherein receiving the paging support indication comprises: receiving the paging support indication in a non-access stratum (NAS) message.

Aspect 18: The method of Aspect 17, wherein receiving the paging support indication comprises: receiving the paging support indication as at least part of a core network controlled subgroup support indication.

Aspect 19: The method of any of Aspects 16-18, wherein transmitting the paging setup indication comprises: transmitting the paging setup indication in a non-access stratum (NAS) message.

Aspect 20: The method of Aspect 19, wherein the paging setup indication is a first paging setup indication that is directed to a user equipment (UE), wherein the network node is a first network node, and wherein the method further comprises: transmitting a second paging setup indication that is directed to a second network node, the second paging setup indication specifying the at least one of the selected N value or the selected Ns value that is based at least in part on the one or more supported Ns values.

Aspect 21: The method of Aspect 19, wherein transmitting the paging setup indication comprises: transmitting the paging setup indication in subgroup identifier assignment signaling.

Aspect 22: The method of any of Aspects 16-21, further comprising: choosing the at least one of the selected N value or the selected Ns value from the at least one of the one or more supported N values or the one or more supported Ns values.

Aspect 23: The method of any of Aspects 16-22, wherein receiving the paging support indication comprises: receiving the paging support indication in radio resource control (RRC) signaling.

Aspect 24: The method of Aspect 23, wherein receiving the paging support indication comprises: receiving the paging support indication as at least part of a user equipment identifier-based subgrouping support indication.

Aspect 25: The method of Aspect 23, wherein receiving the paging support indication comprises: receiving the paging support indication as at least part of UE assistance information.

Aspect 26: The method of Aspect 23, wherein receiving the paging support indication comprises: receiving the paging support indication as at least part of UE capability information.

Aspect 27: The method of any of Aspects 16-26, wherein transmitting the paging setup indication comprises: transmitting the paging setup indication in broadcast signaling.

Aspect 28: The method of Aspect 27, wherein transmitting the paging setup indication comprises: transmitting the paging setup indication as at least part of signaling that indicates a total number of subgroups for UE identifier-based subgrouping in a cell.

Aspect 29: The method of any of Aspects 16-28, wherein the paging setup indication is associated with one or more UE subgroups, and wherein the one or more UE subgroups are associated with a paging occasion.

Aspect 30: The method of any of Aspects 16-29, further comprising: receiving a paging message indication; deriving a paging occasion associated with the paging message indication based at least in part on the at least one of the selected N value or the selected Ns value; and transmitting a paging early indication (PEI) based at least in part on the paging occasion.

Aspect 31: The method of Aspect 30, further comprising: deriving a user equipment (UE) subgroup associated with the PEI based at least in part on a UE identifier, wherein the PEI indicates the UE subgroup.

Aspect 32: A method of wireless communication performed by a network node, comprising: relaying, as a bypass mechanism, a first non-stratum access (NAS) message from a user equipment (UE) to a core network, the first NAS message comprising a paging support indication that specifies at least one of: one or more supported paging frames per paging cycle (N) values, or one or more supported paging occasions per paging frame (Ns) values; relaying, as the bypass mechanism, a second NAS message from the core network to the UE, the second NAS message comprising a paging setup indication that specifies at least one of: a selected N value that is based at least in part on the one or more supported N values, or a selected Ns value that is based at least in part on the one or more supported Ns values; and receiving an indication that is directed to the network node, the indication specifying the at least one of the selected N value or the selected Ns value.

Aspect 33: The method of Aspect 32, wherein receiving the indication that is directed to the network node comprises: receiving the indication as at least part of a message that indicates an assigned subgroup identifier that is associated with the UE.

Aspect 34: The method of any of Aspects 32-33, further comprising: receiving a paging message indication that is directed to the UE; deriving a paging occasion associated with the paging message indication based at least in part on the at least one of the selected N value or the selected Ns value; and transmitting a paging early indication (PEI) based at least in part on the paging occasion.

Aspect 35: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-34.

Aspect 36: An apparatus for wireless communication at a device, the apparatus comprising one or more memories and one or more processors coupled to the one or more memories, the one or more processors configured to cause the device to perform the method of one or more of Aspects 1-34.

Aspect 37: An apparatus for wireless communication, the apparatus comprising at least one means for performing the method of one or more of Aspects 1-34.

Aspect 38: A non-transitory computer-readable medium storing code for wireless communication, the code comprising instructions executable by one or more processors to perform the method of one or more of Aspects 1-34.

Aspect 39: A non-transitory computer-readable medium storing a set of instructions for wireless communication, the set of instructions comprising one or more instructions that, when executed by one or more processors of a device, cause the device to perform the method of one or more of Aspects 1-34.

Aspect 40: A device for wireless communication, the device comprising a processing system that includes one or more processors and one or more memories coupled with the one or more processors, the processing system configured to cause the device to perform the method of one or more of Aspects 1-34.

Aspect 41: An apparatus for wireless communication at a device, the apparatus comprising one or more memories and one or more processors coupled to the one or more memories, the one or more processors individually or collectively configured to cause the device to perform the method of one or more of Aspects 1-34.

Aspect 42: A device comprising a processing system that includes one or more processors and one or more code-storing memories coupled with the one or more processors, the processing system configured to cause the device to perform the method of one or more of Aspects 1-34.

Aspect 43: A device comprising a processing system that includes processor circuitry and code-storing memory circuitry, the processing system configured to cause the device to perform the method of one or more of Aspects 1-34.

Aspect 44: A method, device, apparatus, computer program product, non-transitory computer-readable medium, user equipment, base station, network node, wireless node, wireless communication device, and/or processing system as substantially described herein with reference to and as illustrated by accompanying drawings and specification.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
transmit a paging support indication that specifies support for adaptation to a paging configuration, the adaptation comprising one or more values of one or more parameters of the paging configuration;
and
receive a paging setup indication that specifies the adaptation to the paging configuration.

2. The UE of claim 1, wherein the processing system is configured to cause the UE to:
derive a paging occasion location based at least in part on the adaptation to the paging configuration; and
receive a paging early indication (PEI) that is directed to the UE based at least in part on the paging occasion location.

3. The UE of claim 1, wherein the processing system, to cause the UE to transmit the paging support indication, is configured to cause the UE to:
transmit the paging support indication as at least part of a core network controlled subgroup support indication.

4. The UE of claim 3, wherein the processing system, to cause the UE to transmit the paging support indication, is configured to cause the UE to:
transmit the paging support indication in a non-access stratum (NAS) message.

5. The UE of claim 1, wherein the processing system, to cause the UE to receive the paging setup indication, is configured to cause the UE to:
receive the paging setup indication in a non-access stratum (NAS) message.

6. The UE of claim 5, wherein the processing system, to cause the UE to receive the paging setup indication, is configured to cause the UE to:
receive the paging setup indication in subgroup identifier assignment signaling.

7. The UE of claim 1, wherein the processing system, to cause the UE to transmit the paging support indication, is configured to cause the UE to:
transmit the paging support indication in radio resource control (RRC) signaling.

8. The UE of claim 1, wherein the processing system, to cause the UE to receive the paging setup indication, is configured to cause the UE to:
receive the paging setup indication in broadcast signaling.

9. The UE of claim 1, wherein the paging setup indication indicates at least one of:
a selected N value, wherein Nis a number of paging frames per paging cycle, or
a selected Ns value, wherein Ns is a number of paging occasions per paging frame.

10. The UE of claim 1, wherein the paging setup indication is associated with one or more UE subgroups, and
wherein the one or more UE subgroups are associated with one or more paging occasions.

11. A method of wireless communication performed by a user equipment (UE), comprising:
transmitting a paging support indication that specifies support for adaptation to a paging configuration, the adaptation comprising one or more values of one or more parameters of the paging configuration; and
receiving a paging setup indication that specifies the adaptation to the paging configuration.

12. The method of claim 11, further comprising:
deriving a paging occasion location based at least in part on the adaptation to the paging configuration; and
receiving a paging early indication (PEI) that is directed to the UE based at least in part on the paging occasion location.

13. The method of claim 11, wherein transmitting the paging support indication comprises:
transmitting the paging support indication as at least part of a core network controlled subgroup support indication.

14. The method of claim 11, wherein receiving the paging setup indication comprises:
receiving the paging setup indication in a non-access stratum (NAS) message.

15. The method of claim 11, wherein transmitting the paging support indication comprises:
transmitting the paging support indication in radio resource control (RRC) signaling.

16. The method of claim 11, wherein receiving the paging setup indication comprises:
receiving the paging setup indication in broadcast signaling.

17. The method of claim 11, wherein the paging setup indication indicates at least one of:
a selected N value, wherein Nis a number of paging frames per paging cycle, or
a selected Ns value, wherein Ns is a number of paging occasions per paging frame.

18. The method of claim 11, wherein the paging setup indication is associated with one or more UE subgroups, and
wherein the one or more UE subgroups are associated with one or more paging occasions.

19. A non-transitory computer-readable medium storing a set of instructions for wireless communication, the set of instructions comprising:
one or more instructions that, when executed by one or more processors of a user equipment (UE), cause the UE to:
transmit a paging support indication that specifies support for adaptation to a paging configuration, the adaptation comprising one or more values of one or more parameters of the paging configuration; and
receive a paging setup indication that specifies the adaptation to the paging configuration.

20. The non-transitory computer-readable medium of claim 19, wherein the instructions, when executed by the one or more processors, cause the UE to:
derive a paging occasion location based at least in part on the adaptation to the paging configuration; and
receive a paging early indication (PEI) that is directed to the UE based at least in part on the paging occasion location.
